(19) United States
(12) Patent Application Publication
(10) Pub. No.: US 2017/0206001 A1
(43) Pub. Date: Jul. 20, 2017

(54) METHOD AND APPARATUS FOR GESTURE IDENTIFICATION

(71) Applicant: Beijing Xiaomi Mobile Software Co., Ltd., Beijing (CN)

(72) Inventors: Guosheng LI, Beijing (CN); Wei SUN, Beijing (CN); Zhongsheng JIANG, Beijing (CN)

(73) Assignee: Beijing Xiaomi Mobile Software Co., Ltd.

(21) Appl. No.: 15/408,876

(22) Filed: Jan. 18, 2017

(30) Foreign Application Priority Data
Jan. 19, 2016 (CN) 201610034534.5

(51) Int. Cl. G06F 3/0488; G06F 3/041

(52) U.S. Cl. CPC G06F 3/04883; G06F 3/041; G06F 2203/04101; G06F 2203/04108

(57) ABSTRACT

A gesture identification method is provided for use in a terminal. The terminal includes a touch screen, at least one proximity sensor being distributed in the touch screen and having a transmitter and a receiver. The method includes detecting whether the at least one proximity sensor meets a preset changing rule when the receiver of the at least one proximity sensor receives a reflected signal and a touch operation of the operating object over the touch screen is not detected, determining a position of the at least one proximity sensor when the at least one proximity sensor meets the preset changing rule, and identifying an operating gesture of a user according to the position of the at least one proximity sensor.

### CROSS-REFERENCE TO RELATED APPLICATION

This application is based upon and claims priority to Chinese Patent Application No. 201610034534.5, filed on Jan. 19, 2016, the entire content of which is incorporated herein by reference.

### TECHNICAL FIELD

The present disclosure generally relates to the technical field of display, and more particularly, to a method and apparatus for gesture identification.

### BACKGROUND

With the development of touch screen technology, a touch screen has more and more functions, such as a gesture identification function.

In a conventional technology, a touch screen determines a touch position at which a finger of a user touches the touch screen, and then identifies a gesture of the user according to the touch position. Specifically, the finger of the user needs to contact with the touch screen, and then the terminal may identify an operating gesture of the user, that is, the operating gesture needs to act on the touch screen. Under the condition that it is inconvenient to contact with the touch screen, for example, the finger of the user is unclean, the user may execute a touch operation on the touch screen only after cleaning the finger. This may cause the problem that the user may not timely operate the terminal, or, if the user directly executes the touch operation on the touch screen, the touch screen may be contaminated.

The method and apparatus of the present disclosure is directed towards overcoming one or more the problems set forth above.

### SUMMARY

In one aspect, the present disclosure is directed to a gesture identification method for use in a terminal. The terminal includes a touch screen, and at least one proximity sensor being distributed in the touch screen and having a transmitter and a receiver. The transmitter is configured to send a signal, and the receiver is configured to receive a reflected signal reflected after the signal is blocked by an operating object. The method includes detecting whether the at least one proximity sensor meets a preset changing rule when the receiver of the at least one proximity sensor receives a reflected signal and a touch operation of the operating object over the touch screen is not detected. The preset changing rule is that the receiver of the at least one proximity sensor is switched from reception of no reflected signal to reception of the reflected signal and then is switched from the reception of the reflected signal to reception of no reflected signal. The method further includes determining a position of the at least one proximity sensor when the at least one proximity sensor meets the preset changing rule, and identifying an operating gesture of a user according to the position of the at least one proximity sensor.

In another aspect, the present disclosure is directed to a gesture identification apparatus for use in a terminal. The terminal includes a touch screen, and at least one a proximity sensor being distributed in the touch screen and having a transmitter and a receiver. The transmitter is configured to send a signal, and the receiver is configured to receive a reflected signal reflected after the signal is blocked by an operating object. The apparatus includes a processor and a memory for storing instructions executable by the processor. The processor is configured to detect whether the at least one proximity sensor meets a preset changing rule when the receiver of the at least one proximity sensor receives a reflected signal and a touch operation of the operating object over the touch screen is not detected. The preset changing rule is that the receiver of the at least one proximity sensor is switched from reception of no reflected signal to reception of the reflected signal and then is switched from the reception of the reflected signal to reception of no reflected signal. The processor is further configured to determine a position of the at least one proximity sensor when the at least one proximity sensor meets the preset changing rule, and to identify an operating gesture of a user according to the position of the at least one proximity sensor.

In yet another aspect, the present disclosure is directed to a non-transitory computer-readable storage medium having stored therein instructions that, when executed by a processor of a terminal having a touch screen in which at least one proximity sensor including a transmitter and a receiver is distributed, cause the terminal to perform a method for gesture identification. The method includes detecting whether the at least one proximity sensor meets a preset changing rule when the receiver of the at least one proximity sensor receives a reflected signal and a touch operation of an operating object over the touch screen is not detected. The preset changing rule is that the receiver of the proximity sensor is switched from reception of no reflected signal to reception of the reflected signal and then is switched from the reception of the reflected signal to reception of no reflected signal. The method further includes determining a position of the at least one proximity sensor when the at least one proximity sensor meets the preset changing rule, and identifying an operating gesture of a user according to the position of the at least one proximity sensor.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of embodiments of the present disclosure.

FIG. 1 is a flow chart of a method for gesture identification, according to an exemplary embodiment.

FIG. 2A is a flow chart of method for gesture identification, according to another exemplary embodiment.

FIG. 2B is a schematic diagram illustrating a method for determining an operating position of an operating gesture, according to an exemplary embodiment.

FIG. 2C is a schematic diagram illustrating a method for determining an operating position of an operating gesture, according to another exemplary embodiment.

FIG. 2D is a schematic diagram illustrating a method for identifying an operating gesture, according to an exemplary embodiment.

FIG. 2E is a schematic diagram illustrating a method for identifying an operating gesture, according to another exemplary embodiment.

FIG. 2F is a schematic diagram illustrating a method for identifying an operating gesture, according to still another exemplary embodiment.

FIG. 2G is a flow chart of a method for identifying a speed of an operating gesture, according to an exemplary embodiment.

FIG. 2H is a flow chart of a method for identifying a blocking gesture, according to an exemplary embodiment.

FIG. 2I is a flow chart of a method for identifying a clicking gesture, according to an exemplary embodiment.

FIG. 3 is a block diagram of a gesture identification apparatus, according to an exemplary embodiment.

FIG. 4 is a block diagram of a gesture identification apparatus, according to another exemplary embodiment.

FIG. 5 is a block diagram of a gesture identification apparatus, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely exemplary apparatuses and methods consistent with some aspects related to the present disclosure as recited in the appended claims.

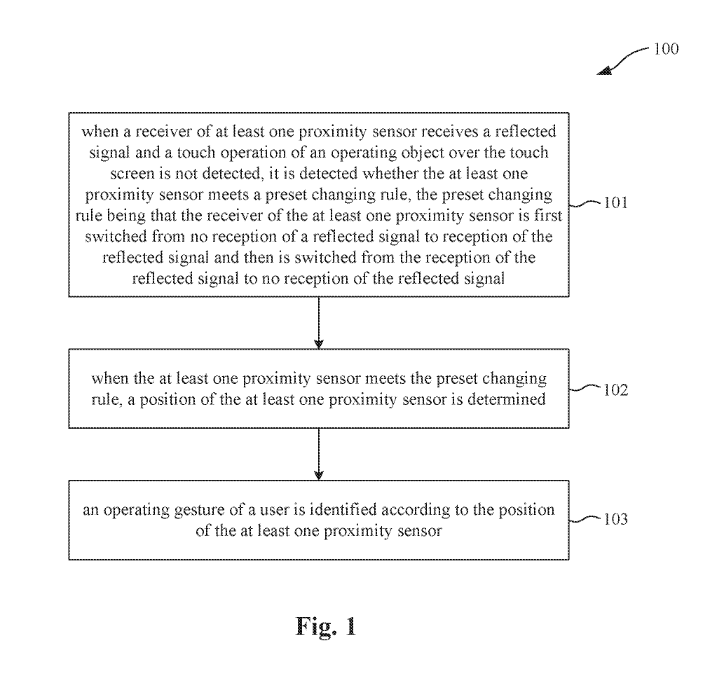

FIG. 1 is a flow chart of a method 100 for gesture identification, according to an exemplary embodiment. The method 100 may be applied to a terminal. The terminal may include a touch screen, and at least one proximity sensor distributed in the touch screen. The at least one proximity sensor may include a transmitter and a receiver. The transmitter is configured to send a signal, and the receiver is configured to receive a reflected signal reflected after the signal is blocked by an operating object. As shown in FIG. 1, the method 100 may include the following steps.

In step 101, when a receiver of at least one proximity sensor receives a reflected signal and a touch operation by an operating object over the touch screen is not detected, it is detected whether the at least one proximity sensor meets a preset changing rule. The preset changing rule may be that the receiver of the at least one proximity sensor is first switched from no reception of the reflected signal to reception of the reflected signal and then is switched from the reception of the reflected signal to no reception of the reflected signal.

In step 102, when the at least one proximity sensor meets the preset changing rule, a position of the at least one proximity sensor is determined.

In step 103, an operating gesture of a user is identified according to the position of the at least one proximity sensor.

In the method 100, when the receiver of the at least one proximity sensor receives the reflected signal and the touch operation by the operating object over the touch screen is not detected, the operating gesture of the user is identified according to the position of the at least one proximity sensor, if it is detected that the receiver is first switched from no reception of the reflected signal to reception of the reflected signal and then is switched from the reception of the reflected signal to no reception of the reflected signal. In this way, the terminal can identify the operating gesture of the user even when the user does not execute a touch operation on the touch screen, thereby solving the problem that the terminal cannot identify the operating gesture of the user when it is inconvenient for the user to execute the touch operation on the touch screen. As such, gesture identification manners may be increased, and gesture identification flexibility may be improved.

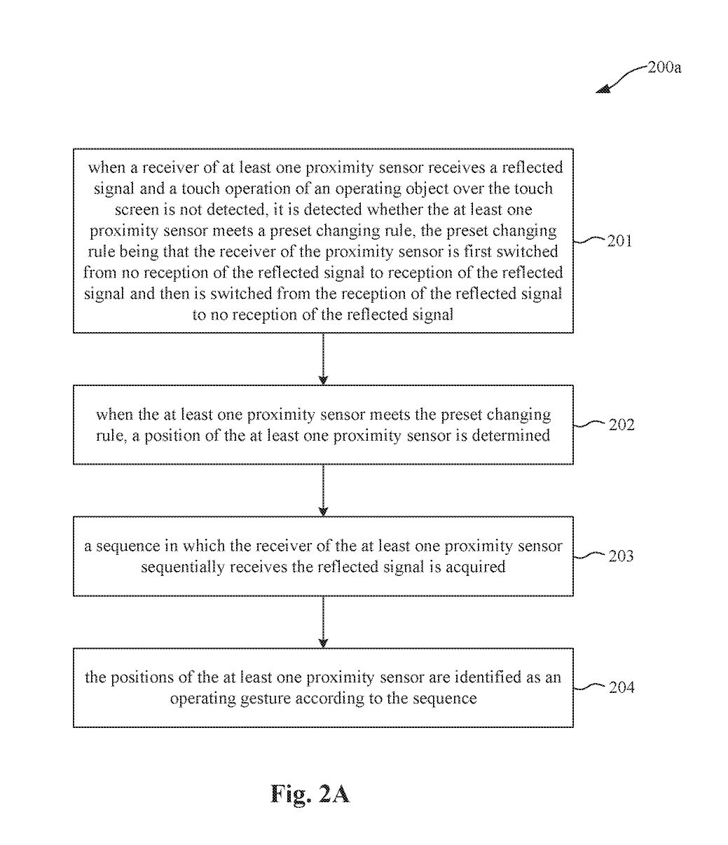

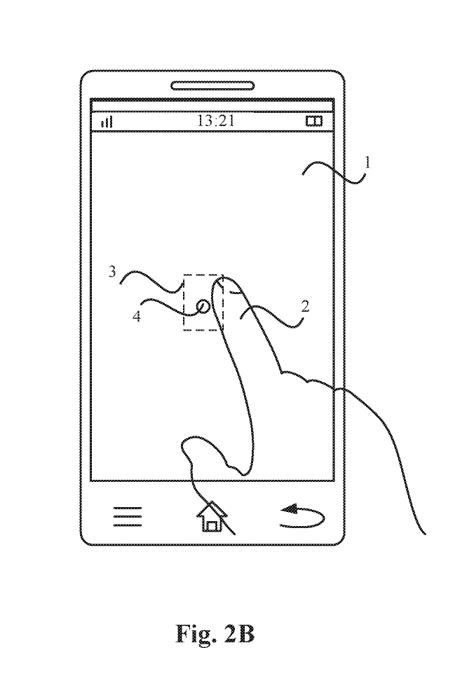

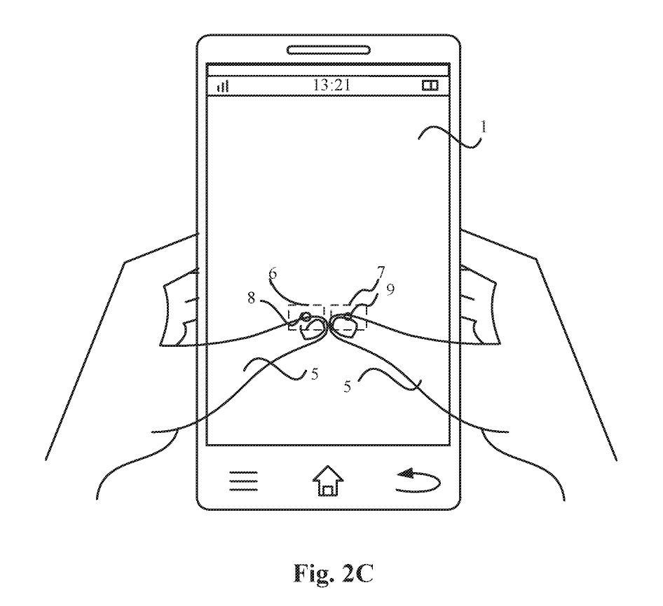

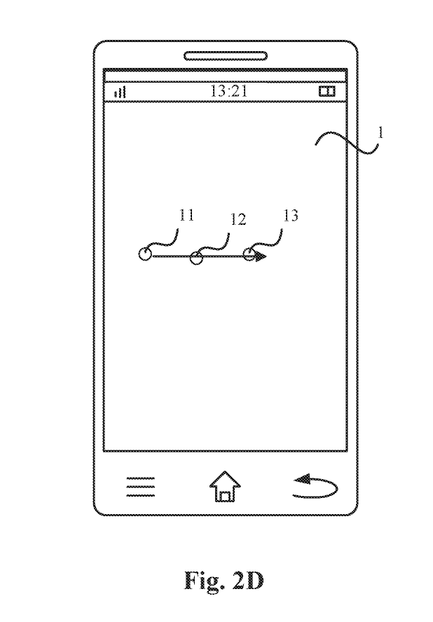

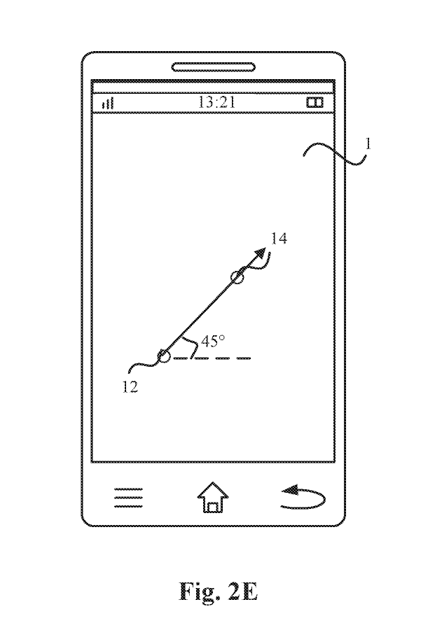

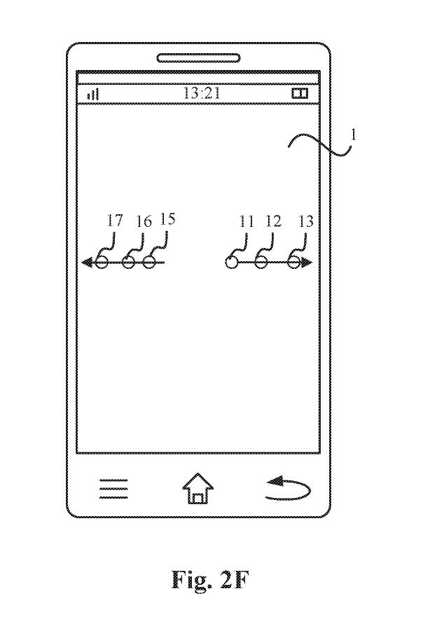

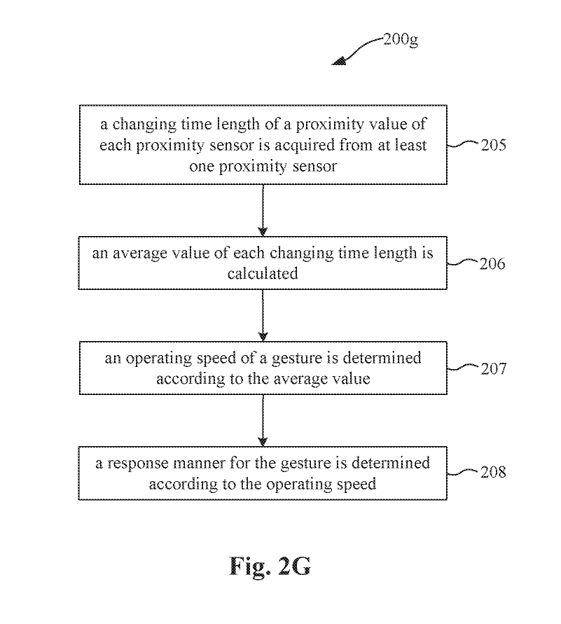

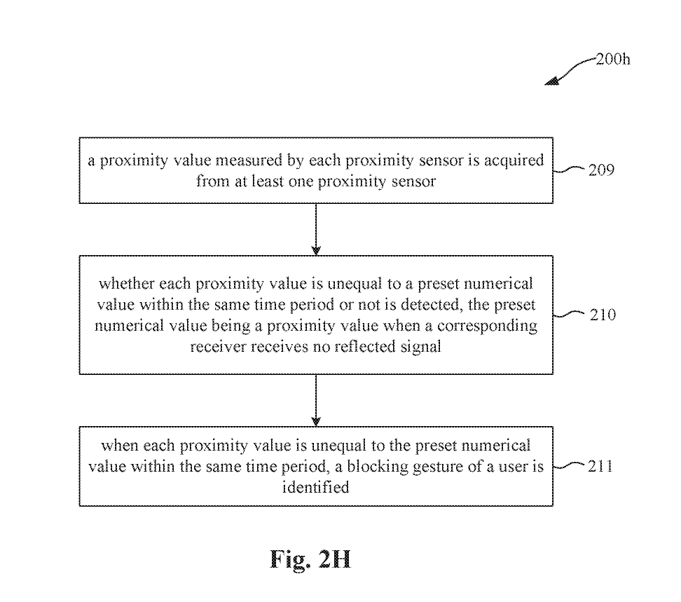

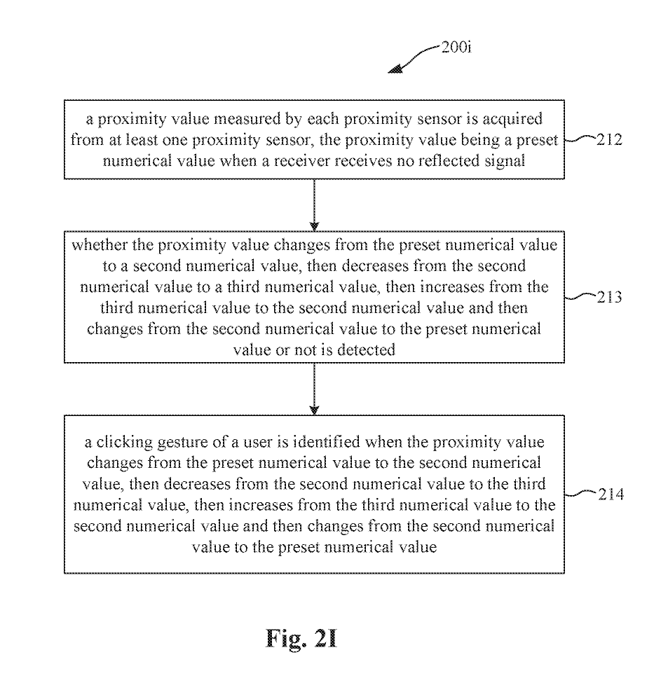

FIG. 2A is a flow chart of a method 200a for gesture identification, according to another exemplary embodiment. The method 200a may be applied to a terminal including a touch screen and at least one proximity sensor distributed in the touch screen. The at least one proximity sensor may include a transmitter and a receiver. The transmitter is configured to send a signal, and the receiver is configured to receive a reflected signal reflected after the signal is blocked by an operating object. The method 200a may be used for identifying an operating gesture of a user without the user's finger directly contacting with the touch screen. As shown in FIG. 2, the gesture identification method 200a may include the following steps.

In step 201, when a receiver of at least one proximity sensor receives a reflected signal and a touch operation by an operating object over the touch screen is not detected, it is detected whether the at least one proximity sensor meets a preset changing rule.

The preset changing rule may be that the receiver of the at least one proximity sensor is first switched from no reception of the reflected signal to reception of the reflected signal and then is switched from the reception of the reflected signal to no reception of the reflected signal.

In exemplary embodiments, the at least one proximity sensor may be a first type or a second type. A transmitter of a proximity sensor of the first type sends an infrared signal; and a receiver of the proximity sensor of the first type may receive a reflected signal of the infrared signal when there is an object approaching the proximity sensor. And, the shorter of a distance between the approaching object and the proximity sensor, the higher of a light intensity of the reflected signal received by the receiver. Accordingly, the proximity sensor of the first type may determine a proximity value between the approaching object and the proximity sensor according to the light intensity of the reflected signal received by the receiver.

A transmitter of a proximity sensor of the second type sends an ultrasonic signal, and the transmitter and a receiver of the proximity sensor work alternately. When there is an object approaching the proximity sensor, the receiver may receive a reflected signal of the ultrasonic signal. And, the shorter of a distance between the approaching object and the proximity sensor, the less of a time for the receiver to receive the reflected signal. Accordingly, the proximity sensor of the second type may determine a proximity value between the approaching object and the proximity sensor according to the time taken by the receiver to receive the reflected signal.

In the present disclosure, a proximity sensor of any type may determine a proximity value when an object approaches the proximity sensor. Thus, the proximity sensor may determine whether the object approaches or not according to the proximity value, and report a proximity event to the terminal when the object approaches.

The terminal detects whether there is a touch operation over the touch screen after receiving the proximity event reported by the at least one proximity sensor. If the touch operation occurs over the touch screen, it is indicated that the proximity event is an operating gesture acting on the touch screen. If there is no touch operation over the touch screen, it is indicated that the proximity event is an operating gesture not acting on the touch screen.

If the operating gesture is a swiping gesture, for at least one proximity sensor approached during an operating process of the swiping gesture, the receiver of the proximity sensor is first switched from no reception of a reflected signal to reception of the reflected signal and then is switched from the reception of the reflected signal to no reception of the reflected signal. Accordingly, it may be identified whether the operating gesture of the user is the swiping gesture by detecting whether the at least one proximity sensor meets the above preset changing rule.

In exemplary embodiments, a method for detecting whether the at least one proximity sensor meets the preset changing rule may include acquiring a proximity value measured by the at least one proximity sensor. The proximity value is configured to indicate a distance between the operating object and the proximity sensor, and is further configured to be a preset numerical value when the receiver of the proximity sensor receives no reflected signal. The method may further include detecting whether the proximity value first changes from the preset numerical value to a first numerical value and then changes from the first numerical value to the preset numerical value. The method may further include determining that the receiver of the proximity sensor is switched from no reception of a reflected signal to reception of the reflected signal and then is switched from the reception of the reflected signal to no reception of the reflected signal and the preset changing rule is met, when the proximity value changes first from the preset numerical value to the first numerical value and then changes from the first numerical value to the preset numerical value.

When the receiver of the proximity sensor receives no reflected signal, the proximity value of the proximity sensor is a preset threshold/value. The preset threshold may be null; alternatively, the preset threshold may a large value, for example an infinity or 10 meters. Alternatively, the preset threshold may be a value indicative of a proximity level, for example, 0 representing a closer proximity level, 1 representing a close proximity level, and 2 representing a far proximity level. In the exemplary embodiments, the preset numerical value may be set to be 2. A setting manner for the preset threshold is not limited in this disclosure.

When the receiver of the proximity sensor receives the reflected signal, the proximity sensor may measure a proximity value. The proximity value is relatively smaller when the approaching object is relatively closer to the proximity sensor. The proximity value is relatively larger when the approaching object is relatively farer from the proximity sensor.

In this way, a change of the proximity sensor may be determined according to a change of the proximity value. That is, when the proximity value changes from the preset numerical value to a first numerical value, it is determined that the receiver of the proximity sensor is switched from no reception of the reflected signal to reception of the reflected signal. When the proximity value changes from the first numerical value to the preset numerical value, it is determined that the receiver of the proximity sensor is switched from reception of the reflected signal to no reception of the reflected signal. The first numerical value may be a fixed numerical value or a variable numerical value, which will not be limited in the embodiment.

In step 202, when the at least one proximity sensor meets the preset changing rule, a position of the at least one proximity sensor is determined.

When the user makes an operating gesture at a present moment, the receiver of the at least one proximity sensor may receive a reflected signal since a finger of the user may be approaching the proximity sensor. An area is formed by the at least one proximity sensor of which the receiver receives the reflected signal. In the exemplary embodiments, a position of a proximity sensor at a central position of the formed area may be determined as the position of the proximity sensor which meets the preset changing rule at the present moment, i.e., an operating position of the operating gesture at the present moment.

For example, as shown in FIG. 2B, a user makes an operating gesture 2 at a certain moment. Proximity sensors whose receivers receive reflected signals form an area 3 on a terminal 1. The terminal 1 obtains, by calculation, a central point 4 of a position of the at least one proximity sensor, and determines the central point 4 as an operating position of the operating gesture at the moment.

For another example, as shown in FIG. 2C, a user makes an operating gesture 5 at a certain moment. Proximity sensors whose receivers receive reflected signals form an area 6 and an area 7 on the terminal 1. The terminal 1 obtains, by calculation, a central point 8 of a position of the at least one proximity sensor corresponding to the area 6. The terminal 1 also obtains, by calculation, a central point 9 of a position of the at least one proximity sensor corresponding to the area 7. The terminal 1 determines the central point 8 and the central point 9 as operating positions of the operating gesture at the moment.

The terminal determines operating positions of the operating gesture at each moment according to the position of the at least one proximity sensor, and may identify the operating gesture of the user according to the operating positions at each moment.

In step 203, a sequence in which the receiver of the at least one proximity sensor sequentially receives the reflected signal is acquired.

If the proximity sensor reports the proximity event to the terminal, the terminal may record a time of reception of the proximity event when the proximity event is received. Therefore, when the operating gesture of a user is generated by continuous actions, such as a swiping operation, the terminal may acquire a time sequence in which the at least one proximity sensor is sequentially approached, and determine a sequence in which the at least one proximity sensor is sequentially approached according to the acquired time sequence.

In step 204, the positions of the at least one proximity sensor are identified as an operating gesture according to the sequence.

An operating trace of the operating gesture without contact with the touch screen may be obtained according to the operating positions, determined in step 202, of the operating gesture at each moment. An operating direction of the operating gesture may be obtained according to the sequence, determined in step 203, in which the at least one proximity sensor is sequentially blocked. The terminal may identify the operating gesture of the user according to the operating trace and the operating direction.

For example, as shown in FIG. 2D, in terminal 1, an operating position 11 is determined at a first moment, an operating position 12 is determined at a second moment, and an operating position 13 is determined at a third moment. The operating gesture of the user is identified to be a rightward swiping gesture according to the determined positions and a sequence of the determined positions.

In some embodiments, the terminal may also set a first angle threshold and a second angle threshold to determine an operating direction of an operating gesture. The second angle threshold is greater than the first angle threshold. The terminal may randomly select two operating positions determined at two different moments, respectively. If an angle between a connecting line of the two operating positions and a horizontal direction is less than the first angle threshold, the operating gesture may be identified to be a leftward or rightward swiping operation. If the angle between the connecting line of the two operating positions and the horizontal direction is greater than the first angle threshold and smaller than the second angle threshold, the operating gesture may be identified to be an inclined swiping operation. If the angle between the connecting line of the two operating positions and the horizontal direction is greater than the second angle threshold, the operating gesture may be identified to be an upward or downward swiping operation.

For example, as shown in FIG. 2E, a first angle threshold may be set to be 30 degrees and a second angle threshold may be set to be 60 degrees in the terminal 1. A randomly selected operating position 12 is determined at a first moment and a randomly selected operating position 14 is determined at a second moment. An angle between a connecting line of the two operating positions 12 and 14 and a horizontal direction is 45 degrees, which is greater than the first angle threshold and smaller than the second angle threshold. As such, the terminal 1 may identify the operating gesture of the user to be an upward and rightward swiping gesture according to determined positions, a sequence of the determined positions, and the angle between the connecting line of the positions and the horizontal direction.

In some embodiments, the terminal 1 may calculate an average value of angles between the connecting lines of two operating positions at adjacent moments of each group and the horizontal direction. The average value is compared with a first angle threshold and a second angle threshold. If the average value is smaller than the first angle threshold, the operating gesture may be identified to be a leftward or rightward swiping operation. If the average value is greater than the first angle threshold and smaller than the second angle threshold, the operating gesture may be identified to be an inclined swiping operation. If the average value is greater than the second angle threshold, the operating gesture may be identified to be an upward or downward swiping operation.

In some embodiments, when the terminal determines at least two operating positions at the same moment, for each of the at least two operating positions, an operation combination may be determined to be the operating position itself and an operating position at an adjacent moment that is closest to the operating position. The operating gesture of the user may be identified according to each determined operation combination.

For example, as shown in FIG. 2F, in terminal 1, operating positions 11 and 15 are determined at a first moment, operating positions 12 and 16 are determined at a second moment, and operating positions 13 and 17 are determined at a third moment. The terminal 1 may determine operating positions 11, 12 and 13 as a first operation combination, and operating positions 15, 16 and 17 as a second operation combination. The terminal 1 may identify the operating gesture of the user according to the determined first and second operation combinations.

In some embodiments, in order to provide more means for responding to the operating gesture, the touch screen may also identify a speed of the operating gesture. FIG. 2G is a flow chart for a method 200g for identifying a speed of an operating gesture, according to an exemplary embodiment. The method 200g may be applied to a terminal including a touch screen. At least one proximity sensor is distributed in the touch screen. The at least one proximity sensor includes a transmitter and a receiver. The transmitter is configured to send a signal, and the receiver is configured to receive a reflected signal reflected after the signal is blocked by an operating object. As shown in FIG. 2G the method 200g may include the following steps.

In step 205, a changing time length of a proximity value of each proximity sensor is acquired from at least one proximity sensor.

In some embodiments, for each proximity sensor, the terminal records a time during which the proximity value of the proximity sensor is unequal to a preset numerical value. When the proximity sensor meets a preset changing rule, the terminal may calculate, according to the recorded time, the changing time length during which the proximity value of the proximity sensor is unequal to the preset numerical value. Alternatively, the terminal may acquire, before detecting whether the proximity sensor meets the preset changing rule, the changing time length during which the proximity value of the proximity sensor is unequal to the preset numerical value. The terminal may directly read the acquired changing time length when detecting that the proximity sensor meets the preset changing rule. There are no limits made to time when the terminal acquires the changing time length during which the proximity value is unequal to the preset numerical value.

In step 206, an average value of each changing time length is calculated. The terminal calculates the average value of each acquired changing time length. Alternatively the terminal may select at least one changing time length from the acquired changing time lengths, and calculate an average value of the at least one changing time length.

In step 207, an operating speed of a gesture is determined according to the average value. A time threshold may be preset in the terminal, and the operating speed of the gesture may be determined by comparing the average value with the time threshold. There may be one or more time thresholds.

For example, two time thresholds are set in the terminal, i.e., a first time threshold and a second time threshold, and the first time threshold is greater than the second time threshold. If the average value is larger than the first time threshold, the terminal may determine that the gesture is a low-speed gesture. If the average value is smaller than the second time threshold, the terminal may determine that the gesture is a high-speed gesture. If the average value is larger than the second time threshold and smaller than the first time threshold, the terminal may determine that the gesture is a medium-speed gesture.

In step 208, a response manner for the gesture is determined according to the operating speed. A response manner of the terminal to the operating gesture may be added by identifying the operating speed of the operating gesture.

For example, a response manner corresponding to a high-speed rightward swiping gesture may be a fast forward of a video. A response manner corresponding to a low-speed rightward swiping gesture may be a jump to the next video.

In some embodiments, a method for identifying a blocking gesture of a user is provided. FIG. 2H is a flow chart for a method 200h for identifying a blocking gesture. The method 200h may include the following steps.

In step 209, a proximity value measured by each proximity sensor is acquired from at least one proximity sensor.

In step 210, whether each proximity value is unequal to a preset numerical value within a same time period is detected. The preset numerical value is a proximity value when the receiver of the proximity receives no reflected signal.

If at least one proximity value at the same moment is detected by the terminal, the terminal continues detecting whether the at least one proximity value remains unequal to the preset numerical value within the same time period.

In step 211, when each proximity value is unequal to the preset numerical value within the same time period, the blocking gesture of the user is identified.

The terminal may identify that the operating gesture of the user is a blocking gesture when each proximity value remains unequal to the preset numerical value within the same time period. The terminal identifies the blocking gesture of the user and extends the response manner to the operating gesture. For example, when the terminal identifies that the user makes a blocking gesture, a corresponding response manner is pausing a video or music. Alternatively when the terminal identifies that the user makes a blocking gesture, a corresponding response manner is clicking a certain application program.

In some embodiments, a first preset time may further be set in the terminal. When a time length for which each proximity value remains unequal to the preset numerical value is longer than or equal to the first preset time, the operating gesture of the user is identified to be a first type of blocking gesture. Alternatively, a second preset time is set in the terminal. When the time length for which each proximity value remains unequal to the preset numerical value is shorter than or equal to the second preset time, the operating gesture of the user is identified to be a second type of blocking gesture. The terminal may set different response manners for different types of blocking gestures.

In some embodiments, a method for identifying a clicking gesture of a user is provided. FIG. 2I is a flow chart for a method 200i for identifying a clicking gesture. The method 200i may include the following steps.

In step 212, a proximity value measured by each proximity sensor is acquired from at least one proximity sensor. The proximity value is a preset numerical value when the receiver of the proximity sensor receives no reflected signal.

In step 213, it is detected whether the proximity value changes from the preset numerical value to a second numerical value, then decreases from the second numerical value to a third numerical value, then increases from the third numerical value to the second numerical value, and then changes from the second numerical value to the preset numerical value.

For example, the operating gesture is a clicking gesture. For each proximity sensor approached in the operating process of the clicking gesture, the measured proximity value gradually decreases from the preset numerical value and then gradually increases to the preset numerical value. As a result, whether the gesture made by the user is a clicking gesture, may be identified by detecting whether the proximity value of at least one proximity sensor meets such a changing trend.

In step 214, when the proximity value changes from the preset numerical value to the second numerical value, then decreases from the second numerical value to the third numerical value, then increases from the third numerical value to the second numerical value, and then changes from the second numerical value to the preset numerical value, a clicking gesture of the user is identified.

For each proximity sensor, when the terminal detects that the proximity value of the proximity sensor changes from the preset numerical value to the second numerical value, it is indicated that an object approaches the proximity sensor. If the proximity value continues changing and decreases from the second numerical value to the third numerical value, it is indicated that a distance between the object and the proximity is shortened. If the proximity value continues changing, and increases from the third numerical value to the second numerical value, and then increases to the preset numerical value, it is indicated that the object gradually gets far away from the proximity sensor and that a proximity value changing rule corresponding to the clicking gesture is met. The third numerical value may be variable, and different clicking gestures may correspond to different third numerical values.

In the above methods, when a receiver of at least one proximity sensor receives a reflected signal, and a touch operation of an operating object over the touch screen is not detected, an operating gesture of a user may be identified according to a position of the at least one proximity sensor, if it is detected that the receiver is switched from reception of no reflected signal to reception of the reflected signal and then is switched from the reception of the reflected signal to reception of no reflected signal. In this way, a terminal may identify the operating gesture of the user without the user's touch on the touch screen, thereby solving the problem that the terminal may not identify the operating gesture of the user when it is inconvenient for the user to execute the touch operation on the touch screen. In addition, gesture identification manners may be increased, and gesture identification flexibility may be improved.

In addition, the operating gesture can be extended by identifying a blocking gesture, a clicking gesture and a speed of an operating gesture, thereby solving the problem that there are fewer manners for the touch screen to respond to the operating gesture due to the fact that the user executes fewer operating gestures when not contacting with the touch screen. As a result, manners for the touch screen to respond to the operating gesture may be increased.

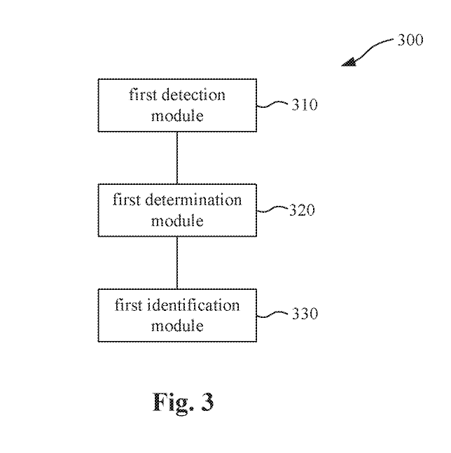

FIG. 3 is a block diagram of a gesture identification apparatus 300, according to an exemplary embodiment. The apparatus 300 may be applied to a terminal including a touch screen. At least one proximity sensor is distributed in the touch screen. The proximity sensor may include a transmitter and a receiver. The transmitter is configured to send a signal, and the receiver is configured to receive a reflected signal reflected after the signal is blocked by an operating object. As shown in FIG. 3, the gesture identification apparatus 300 may include a first detection module 310, a first determination module 320, and a first identification module 330.

The first detection module 310 is configured to, when the receiver of the at least one proximity sensor receives a reflected signal and a touch operation of the operating object over the touch screen is not detected, detect whether the at least one proximity sensor meets a preset changing rule. The preset changing rule may include that the receiver of the proximity sensor is switched from reception of no reflected signal to reception of the reflected signal and then is switched from the reception of the reflected signal to reception of no reflected signal.

The first determination module 320 is configured to, when a detection result of the first detection module 310 is that the at least one proximity sensor meets the preset changing rule, determine a position of the at least one proximity sensor.

The first identification module 330 is configured to identify an operating gesture of a user according to the position, determined by the first determination module 320, of the at least one proximity sensor.

According to the gesture identification apparatus 300 provided by the present disclosure, when a receiver of at least one proximity sensor receives a reflected signal and a touch operation of an operating object over the touch screen is not detected, an operating gesture of a user may be identified according to a position of the at least one proximity sensor if it is detected that the receiver is switched from reception of no reflected signal to reception of the reflected signal and then is switched from reception of the reflected signal to reception of no reflected signal. In this way, the terminal may identify the operating gesture of the user even when the user does not execute a touch operation on the touch screen, thereby solving the problem that the terminal may not identify the operating gesture of the user when it is inconvenient for the user to execute the touch operation on the touch screen. In addition, gesture identification manners may be increased, and gesture identification flexibility may be improved.

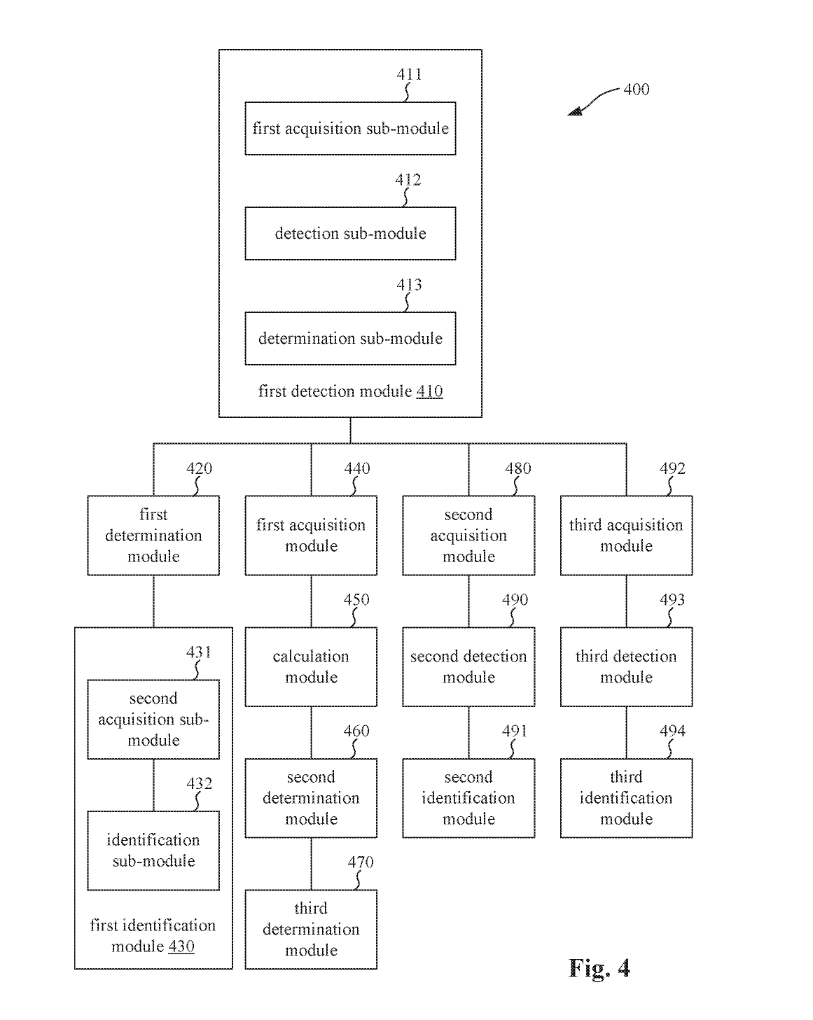

FIG. 4 is a block diagram of a gesture identification apparatus 400 according to an exemplary embodiment. The gesture identification apparatus 400 may be applied to a terminal including a touch screen. At least one proximity sensor is distributed in the touch screen. The proximity sensor may include a transmitter and a receiver. The transmitter is configured to send a signal and the receiver is configured to receive a reflected signal reflected after the signal is blocked by an operating object. As shown in FIG. 4, the gesture identification apparatus 400 may include a first detection module 410, a first determination module 420 and a first identification module 430.

The first detection module 410 is configured to detect whether the at least one proximity sensor meets a preset changing rule, when the receiver of the at least one proximity sensor receives a reflected signal and a touch operation of the operating object over the touch screen is not detected. The preset changing rule may be that the receiver of the proximity sensor is switched from reception of no reflected signal to reception of the reflected signal and then is switched from reception of the reflected signal to reception of no reflected signal.

The first determination module 420 is configured to determine a position of the at least one proximity sensor when a detection result of the first detection module 410 is that the at least one proximity sensor meets the preset changing rule.

The first identification module 430 is configured to identify an operating gesture of a user according to the position, determined by the first determination module 420, of the at least one proximity sensor.

In some embodiments, the first detection module 410 may include a first acquisition sub-module 411, a detection sub-module 412 and a determination sub-module 413.

The first acquisition sub-module 411 is configured to, for each proximity sensor, acquire a proximity value measured by the proximity sensor. The proximity value is configured to indicate a distance between the operating object and the proximity sensor. The proximity value may be a preset numerical value when the receiver of the proximity sensor receives no reflected signal.

The detection sub-module 412 is configured to detect whether the proximity value, acquired by the first acquisition sub-module 411, changes from the preset numerical value to a first numerical value and then changes from the first numerical value to the preset numerical value.

The determination sub-module 413 is configured to, when a detection result of the detection sub-module 412 is that the proximity value changes from the preset numerical value to the first numerical value and then changes from the first numerical value to the preset numerical value, determine that the receiver of the proximity sensor is switched from reception of no reflected signal to reception of the reflected signal and then is switched from reception of the reflected signal to reception of no reflected signal and the preset changing rule is met.

In some embodiments, the first identification module 430 may include a second acquisition sub-module 431 and an identification sub-module 432.

The second acquisition sub-module 431 is configured to acquire a sequence in which the receiver of the at least one proximity sensor sequentially receives the reflected signal.

The identification sub-module 432 is configured to identify the position of the at least one proximity sensor as the operating gesture according to the sequence acquired by the second acquisition sub-module 431.

In some embodiments, the apparatus 400 may further include a first acquisition module 440, a calculation module 450, a second determination module 460 and a third determination module 470.

The first acquisition module 440 is configured to acquire, from the at least one proximity sensor, a changing time length of the proximity value of each proximity sensor.

The calculation module 450 is configured to calculate an average value of each changing time length acquired by the first acquisition module 440.

The second determination module 460 is configured to determine an operating speed of the gesture according to the average value calculated by the calculation module 450.

The third determination module 470 is configured to determine a response manner for the gesture according to the operating speed determined by the second determination module 460.

In some embodiments, the apparatus 400 may further include a second acquisition module 480, a second detection module 490 and a second identification module 491.

The second acquisition module 480 is configured to acquire, from the at least one proximity sensor, a proximity value measured by each proximity sensor.

The second detection module 490 is configured to detect whether each proximity value, acquired by the second acquisition module 480, is unequal to a preset numerical value within the same time period. The preset numerical value may be a proximity value when the corresponding receiver receives no reflected signal.

The second identification module 491 is configured to, when a detection result of the second detection module 490 is that each proximity value is unequal to the preset numerical value within the same time period, identify a blocking gesture of the user.

In some embodiments, the apparatus 400 may further include a third acquisition module 492, a third detection module 493 and a third identification module 494.

The third acquisition module 492 is configured to acquire a proximity value measured by each proximity sensor in the at least one proximity sensor. The proximity value may be a preset numerical value when the receiver of the proximity sensor receives no reflected signal.

The third detection module 493 is configured to detect whether the proximity value, acquired by the third acquisition module 492, changes from the preset numerical value to a second numerical value, then decreases from the second numerical value to a third numerical value, then increases from the third numerical value to the second numerical value and then changes from the second numerical value to the preset numerical value.

The third identification module 494 is configured to identify a clicking gesture of the user when a detection result of the third detection module 493 is that the proximity value changes from the preset numerical value to the second numerical value, then decreases from the second numerical value to the third numerical value, then increases from the third numerical value to the second numerical value and then changes from the second numerical value to the preset numerical value.

According to the gesture identification apparatuses provided by the present disclosure, when a receiver of at least one proximity sensor receives a reflected signal and a touch operation of an operating body over a touch screen is not detected, an operating gesture of a user is identified according to a position of the at least one proximity sensor if it is detected that the receiver is switched from reception of no reflected signal to reception of the reflected signal and then is switched from reception of the reflected signal to reception of no reflected signal. In this way, a terminal may identify the operating gesture of the user even when the user does not execute touch operation on the touch screen, thereby solving the problem that the terminal may not identify the operating gesture of the user when it is inconvenient for the user to execute the touch operation on the touch screen. As a result, gesture identification manners may be increased, and improving gesture identification flexibility are achieved.

In addition, the operating gesture can be extended by identifying a blocking gesture, a clicking gesture and a speed of an operating gesture, thereby solving the problem that there are fewer response manners for the touch screen to respond to the operating gesture due to the fact that the user executes fewer operating gestures when not contacting with the touch screen. Accordingly, manners for responses of the touch screen to the operating gesture may be increased.

With respect to the apparatuses in the above embodiments, the specific manners for performing operations for individual modules therein have been described in detail in the above methods, which will not be repeated herein.

In some embodiments of the present disclosure, a gesture identification apparatus may be provided to implement the gesture identification methods provided by the present disclosure. The apparatus may be applied to a touch screen. At least one proximity sensor is distributed in the touch screen. The proximity sensor may include a transmitter and a receiver. The transmitter is configured to send a signal, and the receiver is configured to receive a reflected signal reflected after the signal is blocked by an operating object. The gesture identification apparatus may include a processor and a memory configured to store instructions executable by the processor,

The processor may be configured to detect whether the at least one proximity sensor meets a preset changing rule when the receiver of the at least one proximity sensor receives a reflected signal and a touch operation of the operating object over the touch screen is not detected. The preset changing rule may be that the receiver of the proximity sensor is switched from reception of no reflected signal to reception of the reflected signal and then is switched from reception of the reflected signal to reception of no reflected signal. The processor may be further configured to, determine a position of the at least one proximity sensor when the at least one proximity sensor meets the preset changing rule. The processor may further be configured to identify an operating gesture of a user according to the position of the at least one proximity sensor.

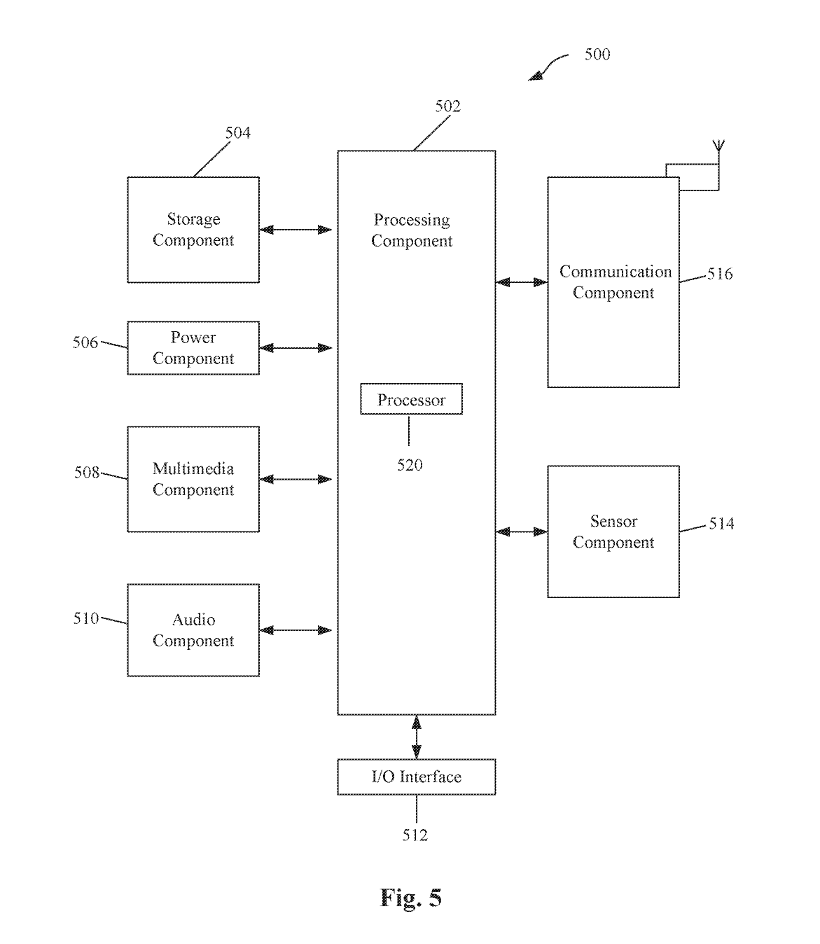

FIG. 5 is a block diagram of a gesture identification apparatus 500, according to an exemplary embodiment. The apparatus 500 may be, for example, a mobile phone, a computer, a digital broadcast terminal, a messaging device, a game console, a tablet, a medical device, fitness equipment, a personal digital assistant and the like.

Referring to FIG. 5, the apparatus 500 may include one or more of the following components: a processing component 502, a storage component 504, a power component 506, a multimedia component 508, an audio component 510, an input/output (I/O) interface 512, a sensor component 514, and a communication component 516.

The processing component 502 typically controls overall operations of the apparatus 500, such as the operations associated with display, telephone calls, data communications, camera operations, and/or recording operations. The processing component 502 may include one or more processors 520 that execute instructions to perform all or part of the steps in the abovementioned methods. Moreover, the processing component 502 may include one or more modules which facilitate interactions between the processing component 502 and the other components. For instance, the processing component 502 may include a multimedia module to facilitate interactions between the multimedia component 508 and the processing component 502.

The storage component 504 is configured to store various types of data to support the operations of the apparatus 500. Examples of such data may include instructions for any application programs or methods operated on the apparatus 500, contact data, phonebook data, messages, pictures, video, etc. The storage component 504 may be implemented by any type of volatile or non-volatile memory devices, and/or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, and a magnetic or optical disk.

The power component 506 provides power for various components of the apparatus 500. The power component 506 may include a power management system, one or more power supplies, and other components associated with the generation, management and distribution of power for the apparatus 500.

The multimedia component 508 may include a screen providing an output interface between the apparatus 500 and a user. In some embodiments, the screen may include a liquid crystal display (LCD) and/or a touch panel (TP). If the screen includes the TP, the screen may embody as a touch screen to receive an input signal from a user. The TP may include one or more touch sensors to sense touches, swipes and gestures on the TP. The touch sensors may not only sense a boundary of a touch or swipe action, but also sense a time duration and pressure associated with the touch or swipe action. In some embodiments, the multimedia component 508 may include a front camera and/or a rear camera. The front camera and/or the rear camera may receive external multimedia data when the apparatus 500 is in an operation mode, such as a photographing mode or a video mode. Each of the front camera and the rear camera may be a fixed optical lens system or have focusing and optical zooming capabilities.

The audio component 510 is configured to output and/or input an audio signal. For example, the audio component 510 may include a Microphone (MIC). The MIC is configured to receive an external audio signal when the apparatus 500 is in the operation mode, such as a call mode, a recording mode and/or a voice recognition mode. The received audio signal may be further stored in the storage component 504 or sent through the communication component 516. In some embodiments, the audio component 510 may further include a speaker configured to output the audio signal.

The I/O interface 512 provides an interface between the processing component 502 and a peripheral interface module. The peripheral interface module may be a keyboard, a click wheel, a button and the like. The button may include, but are not limited to: a home button, a volume button, a starting button and/or a locking button.

The sensor component 514 includes one or more sensors configured to provide status assessment in various aspects for the apparatus 500. For instance, the sensor component 514 may detect an on/off status of the apparatus 500 and relative positioning of components, such as a display and small keyboard of the apparatus 500. The sensor component 514 may further detect a change in a position of the apparatus 500 or a component of the apparatus 500, presence or absence of contact between a user and the apparatus 500, orientation or acceleration/deceleration of the apparatus 500, and/or a change in temperature of the apparatus 500. The sensor component 514 may include at least one proximity sensor configured to detect presence of an object nearby without any physical contact. The sensor component 514 may also include a light sensor, such as a complementary metal oxide semiconductor (CMOS) or charge coupled device (CCD) image sensor, configured for use in an imaging application. In some embodiments, the sensor component 514 may also include an acceleration sensor, a gyroscope sensor, a magnetic sensor, a pressure sensor, or a temperature sensor.

The communication component 516 is configured to facilitate wired or wireless communications between the apparatus 500 and other device. The apparatus 500 may access a communication-standard-based wireless network, such as a wireless fidelity (WiFi) network, a 2nd-generation (2G) or 3rd-feneration (3G) network, and/or a combination thereof. In an exemplary embodiment, the communication component 516 may receive a broadcast signal from an external broadcast management system or broadcast associated information through a broadcast channel. In another exemplary embodiment, the communication component 516 may further include a near field communication (NFC) module to facilitate short-range communications. For example, the NFC module may be implemented on the basis of a radio frequency identification (RFID) technology, an infrared data association (IrDA) technology, an ultra-wideband (UWB) technology, a BlueTooth (BT) technology, and/or other technology.

In an exemplary embodiment, the apparatus 500 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electronic components. which is configured to execute the abovementioned methods.

In an exemplary embodiment, a non-transitory computer-readable storage medium having instructions stored thereon is provided. The instructions may be executed by the processor 520 of the apparatus 500 to implement the above described methods. The non-transitory computer-readable storage medium may be, for example a ROM, a random access memory (RAM), a compact disc read-only memory (CD-ROM), a magnetic tape, a floppy disc, an optical data storage device and/or the like.

Other embodiments of the present disclosure will be apparent to those skilled in the art from consideration of the specification and practice of embodiments of the present disclosure. This application is intended to cover any variations, uses, or adaptations of embodiments of the present disclosure following the general principles thereof and including such departures from embodiments of the present disclosure as come within known or customary practice in the art. It is intended that the specification and examples be considered as exemplary only, with a true scope and spirit of embodiments of the present disclosure being indicated by the following claims.

It will be appreciated that embodiments of the present disclosure is not limited to the exact construction that has been described above and illustrated in the accompanying drawings, and that various modifications and changes may be made without departing from the scope thereof. It is intended that the scope of embodiments of the present disclosure only be limited by the appended claims.

What is claimed is:

1. A gesture identification method for use in a terminal, the terminal including a touch screen, and at least one proximity sensor being distributed in the touch screen and having a transmitter and a receiver, the transmitter being configured to send a signal, and the receiver being configured to receive a reflected signal reflected after the signal is blocked by an operating object, the method comprising:
detecting whether the at least one proximity sensor meets a preset changing rule when the receiver of the at least one proximity sensor receives a reflected signal and a touch operation of the operating object over the touch screen is not detected, the preset changing rule being that the receiver of the at least one proximity sensor is switched from reception of no reflected signal to reception of the reflected signal and then is switched from the reception of the reflected signal to reception of no reflected signal;
determining a position of the at least one proximity sensor when the at least one proximity sensor meets the preset changing rule; and
identifying an operating gesture of a user according to the position of the at least one proximity sensor.

2. The method according to claim 1, wherein detecting whether the at least one proximity sensor meets the preset changing rule comprises:
for each of the at least one proximity sensor, acquiring a proximity value measured by the proximity sensor, the proximity value being configured to indicate a distance between the operating object and the proximity sensor and to be a preset numerical value when the receiver of the proximity sensor receives no reflected signal;
detecting whether the proximity value changes from the preset numerical value to a first numerical value and then changes from the first numerical value to the preset numerical value; and
determining that the receiver of the proximity sensor is switched from reception of no reflected signal to reception of the reflected signal and then is switched from the reception of the reflected signal to reception of no reflected signal and the preset changing rule is met, when the proximity value changes from the preset numerical value to the first numerical value and then changes from the first numerical value to the preset numerical value.

3. The method according to claim 1, wherein identifying the operating gesture of the user according to the position of the at least one proximity sensor comprises:
acquiring a sequence in which the receiver of the at least one proximity sensor sequentially receives the reflected signal; and
identifying the position of the at least one proximity sensor as the operating gesture according to the sequence.

4. The method according to claim 1, further comprising:
acquiring a changing time length of the proximity value of each of the at least one proximity sensor;
calculating an average value of the changing time length;
determining an operating speed of the gesture according to the average value; and
determining a response manner for the gesture according to the operating speed.

5. The method according to claim 2, further comprising:
acquiring a changing time length of the proximity value of each of the at least one proximity sensor;
calculating an average value of the changing time length;
determining an operating speed of the gesture according to the average value; and
determining a response manner for the gesture according to the operating speed.

6. The method according to claim 3, further comprising:
acquiring a changing time length of the proximity value of each of the at least one proximity sensor;
calculating an average value of the changing time length;
determining an operating speed of the gesture according to the average value; and
determining a response manner for the gesture according to the operating speed.

7. The method according to claim 1, further comprising:
acquiring a proximity value measured by each of the at least one proximity sensor;
detecting whether the proximity value is unequal to a preset numerical value within a same time period, the preset numerical value being a proximity value when the receiver of the proximity sensor receives no reflected signal; and
identifying a blocking gesture of the user when the proximity value is unequal to the preset numerical value within the same time period.

8. The method according to claim 1, further comprising:
acquiring a proximity value measured by each of the at least one proximity sensor, the proximity value being a preset numerical value when the receiver of the proximity sensor receives no reflected signal;
detecting whether the proximity value changes from the preset numerical value to a second numerical value, then decreases from the second numerical value to a third numerical value, then increases from the third numerical value to the second numerical value and then changes from the second numerical value to the preset numerical value; and
identifying a clicking gesture of the user when the proximity value changes from the preset numerical value to the second numerical value, then decreases from the second numerical value to the third numerical value, then increases from the third numerical value to the second numerical value and then changes from the second numerical value to the preset numerical value.

9. A gesture identification apparatus for use in a terminal, the terminal including a touch screen, and at least one a proximity sensor being distributed in the touch screen and having a transmitter and a receiver, the transmitter being configured to send a signal, and the receiver being configured to receive a reflected signal reflected after the signal is blocked by an operating object, the apparatus comprising:
a processor; and
a memory for storing instructions executable by the processor,
wherein the processor is configured to:
detect whether the at least one proximity sensor meets a preset changing rule when the receiver of the at least one proximity sensor receives a reflected signal and a touch operation of the operating object over the touch screen is not detected, the preset changing rule being that the receiver of the at least one proximity sensor is switched from reception of no reflected signal to reception of the reflected signal and then is switched from the reception of the reflected signal to reception of no reflected signal;
determine a position of the at least one proximity sensor when the at least one proximity sensor meets the preset changing rule; and
identify an operating gesture of a user according to the position of the at least one proximity sensor.

10. The apparatus according to claim 9, wherein the processor is further configured to:
for each of the at least one proximity sensor, acquire a proximity value measured by the proximity sensor, the proximity value being configured to indicate a distance between the operating object and the proximity sensor and to be a preset numerical value when the receiver of the proximity sensor receives no reflected signal;
detect whether the proximity value changes from the preset numerical value to a first numerical value and then changes from the first numerical value to the preset numerical value; and
when a detection result is that the proximity value changes from the preset numerical value to the first numerical value and then changes from the first numerical value to the preset numerical value, determine that the receiver of the proximity sensor is switched from reception of no reflected signal to reception of the reflected signal and then is switched from the reception of the reflected signal to reception of no reflected signal and the preset changing rule is met.

11. The apparatus according to claim 9, wherein the processor is further configured to:
acquire a sequence in which the receiver of the at least one proximity sensor sequentially receives the reflected signal; and
identify the position of the at least one proximity sensor as the operating gesture according to the sequence.

12. The apparatus according to claim 9, wherein the processor is further configured to:
acquire a changing time length of the proximity value of each of the at least one proximity sensor;
calculate an average value of the changing time length;
determine an operating speed of the gesture according to the average value; and
determine a response manner for the gesture according to the operating speed.

13. The apparatus according to claim 10, wherein the processor is further configured to:
acquire a changing time length of the proximity value of each of the at least one proximity sensor;
calculate an average value of the changing time length;
determine an operating speed of the gesture according to the average value; and
determine a response manner for the gesture according to the operating speed.

14. The apparatus according to claim 11, wherein the processor is further configured to:
acquire a changing time length of the proximity value of each of the at least one proximity sensor;
calculate an average value of the changing time length;
determine an operating speed of the gesture according to the average value; and
determine a response manner for the gesture according to the operating speed.

15. The apparatus according to claim 9, wherein the processor is further configured to:
acquire a proximity value measured by each of the at least one proximity sensor;
detect whether the proximity value is unequal to a preset numerical value within a same time period, the preset numerical value being a proximity value when the receiver of the proximity sensor receives no reflected signal; and
identify a blocking gesture of the user when a detection result is that the proximity value is unequal to the preset numerical value within the same time period.

16. The apparatus according to claim 9, wherein the processor is further configured to:
acquire a proximity value measured by each of the at least one proximity sensor, the proximity value being a preset numerical value when the receiver of the proximity sensor receives no reflected signal;
detect whether the proximity value changes from the preset numerical value to a second numerical value, then decreases from the second numerical value to a third numerical value, then increases from the third numerical value to the second numerical value and then changes from the second numerical value to the preset numerical value; and
identify a clicking gesture of the user when a detection result is that the proximity value changes from the preset numerical value to the second numerical value, then decreases from the second numerical value to the third numerical value, then increases from the third numerical value to the second numerical value and then changes from the second numerical value to the preset numerical value.

17. A non-transitory computer-readable storage medium having stored therein instructions that, when executed by a processor of a terminal having a touch screen in which at least one proximity sensor including a transmitter and a receiver is distributed, cause the terminal to perform a method for gesture identification, the method comprising:
when the receiver of the at least one proximity sensor receives a reflected signal and a touch operation of an operating object over the touch screen is not detected, detecting whether the at least one proximity sensor meets a preset changing rule, the preset changing rule being that the receiver of the proximity sensor is switched from reception of no reflected signal to reception of the reflected signal and then is switched from the reception of the reflected signal to reception of no reflected signal;
when the at least one proximity sensor meets the preset changing rule, determining a position of the at least one proximity sensor; and
identifying an operating gesture of a user according to the position of the at least one proximity sensor.
